(19) United States
(12) Patent Application Publication
(10) Pub. No.: US 2021/0096288 A1
(43) Pub. Date: Apr. 1, 2021

(54) INFRARED TRANSMISSIVE PRODUCT

(71) Applicant: TOYODA GOSEI CO., LTD., Kiyosu-shi (JP)

(72) Inventors: Yoshinori YOSHIZAWA, Kiyosu-shi (JP); Shintaro OKAWA, Kiyosu-shi (JP); Hiroaki ANDO, Kiyosu-shi (JP); Seiichi SUZUKI, Saitama-shi (JP)

(21) Appl. No.: 17/029,882

(22) Filed: Sep. 23, 2020

(30) Foreign Application Priority Data
Sep. 30, 2019 (JP) 2019-178628

(51) Int. Cl. G02B 5/20; G02B 1/04; C08J 7/04; C08K 5/00; C08K 3/01

(52) U.S. Cl. CPC G02B 5/208; G02B 1/04; C08K 3/01; C08K 5/0041; C08J 7/0427

(57) ABSTRACT

An infrared transmissive product includes a body. The body includes a base made of a transparent plastic having an infrared transmissivity and a black layer formed on a rear surface of the base in a transmission direction of infrared rays from a transmitting unit. The black layer includes a coating film layer. The coating film layer is formed by combining a transparent plastic and at least two types of dyes/pigments that have an infrared transmissivity and produce a black color when mixed together. The black layer has a thickness in a range from 5 μm to 50 μm. The black layer contains 50 to 150 parts by mass of dyes/pigments as a whole in relation to 100 parts by mass of transparent plastic.

### BACKGROUND

### 1. Field

The present disclosure relates to an infrared transmissive product that includes a body configured to cover an infrared transmitting unit and an infrared receiving unit in an infrared sensor.

### 2. Description of Related Art

Some vehicles are equipped with an infrared sensor in order to detect the surrounding environment. An infrared sensor is configured to transmit infrared rays from a transmitting unit to the outside of the vehicle and receive, at a receiving unit, infrared rays that strike, and are reflected by, an object outside the vehicle, such as a leading vehicle or a pedestrian. Based on the transmitted and received infrared rays, the infrared sensor recognizes the object and detects the distance between the vehicle and the object, and the relative velocity.

If the infrared sensor is provided in an exposed state, the transmitting unit and the receiving unit are visible from the outside of the vehicle. This degrades not only the appearance of the infrared sensor itself, but also the appearance of the section in the vehicle around the infrared sensor. Accordingly, the transmitting unit and the receiving unit of the infrared sensor are typically covered with an infrared transmissive product having an infrared transmissivity, such as an infrared transmissive cover.

As such an infrared transmissive product, one with a base and a black layer has been developed. The base is made of a transparent plastic having an infrared transmissivity. The black layer is formed on the rear surface of the base in the transmission direction of the infrared rays and configured to allow infrared rays to pass through, while limiting passage of visible light rays.

If the black layer is formed by applying a paint made of a single black pigment such as carbon black or Ketjen black, the light transmissivity rises in a section of the wavelength region of visible light rays that is slightly lower than the boundary with the wavelength region of infrared rays. The black layer also has a drawback that, in a specific wavelength region of visible light rays, the light transmissivity is higher than in other regions.

On the other hand, for example, Japanese Laid-Open Patent Publication No. 2017-167484 discloses a hardened body (wavelength selective filter) that limits passage of visible light rays and allows infrared rays to pass through. The hardened body is formed by molding a plastic composition, which will be discussed below, into a predetermined thickness. The plastic composition is formed by combining a light absorbing agent having an infrared transmissivity with a transparent plastic having an infrared transmissivity. Dyes of different colors that produce a black color when mixed together are selected and used as the light absorbing agent. This limits passage of visible light rays in a wider range in the wavelength region of visible light rays.

In this respect, the hardened body of the above-described plastic composition may be replaced by a paint, and the black layer that may be formed by applying the paint is applied to a base.

In this case, since the thickness of the hardened body of the plastic composition disclosed in the above publication is significantly different from the thickness of the black layer made of a coating film, the thickness of the hardened body needs to be matched with the thickness of the black layer when the hardened body is replaced with the paint. However, if the amount of the dye is reduced by the same ratio as the ratio between the thicknesses, visible light rays are more likely to pass through. In order to ensure limited passage of visible light rays, the dye is prepared in the same amount as the amount of the dye in the hardened body, while reducing the thickness. However, when light transmissivities were measured for respective wavelengths in an infrared transmissive product in which a black layer was formed by replacing a hardened body with a paint, it was discovered that passage of infrared rays was insufficient although passage of visible light rays was limited.

### SUMMARY

Accordingly, it is an objective of the present disclosure to provide an infrared transmissive product that is capable of increasing an infrared transmissivity while limiting passage of visible light rays.

In a general aspect, an infrared transmissive product is provided that includes a body configured to cover a transmitting unit and a receiving unit for infrared rays in an infrared sensor. The body includes a base made of a transparent plastic having an infrared transmissivity, and a black layer that is formed on a rear surface of the base in a transmission direction of infrared rays from the transmitting unit. The black layer includes a coating film layer. The coating film layer is formed by combining a transparent plastic and at least two types of dyes/pigments that have an infrared transmissivity and produce a black color when mixed together. The black layer has a thickness in a range from 5 μm to 50 μm. The black layer contains 50 to 150 parts by mass of the dyes/pigments as a whole in relation to 100 parts by mass of the transparent plastic.

In another general aspect, an infrared transmissive product is provided that includes a body configured to cover a transmitting unit and a receiving unit for infrared rays in an infrared sensor. The body includes a base made of a plastic having an infrared transmissivity, and a black layer that is formed on a front surface of the base in a transmission direction of infrared rays from the transmitting unit. The black layer includes a coating film layer. The coating film layer is formed by combining a transparent plastic and at least two types of dyes/pigments that have an infrared transmissivity and produce a black color when mixed together. The black layer has a thickness in a range from 5 μm to 50 μm. The black layer contains 50 to 150 parts by mass of the dyes/pigments as a whole in relation to 100 parts by mass of the transparent plastic.

Other features and aspects will be apparent from the following detailed description, the drawings, and the claims.

### BRIEF DESCRIPTION OF THE DRAWINGS

FIG. 1 is a cross-sectional side view of an infrared transmissive product according to an embodiment, illustrating an infrared sensor and an infrared transmissive cover, which is the infrared transmissive product.

FIG. 2 is a graph showing measurement results of light transmissivities at respective wavelengths in Examples 1, 2 and Replicated Example 1.

FIG. 3 is a cross-sectional side view corresponding to FIG. 1, showing a modification in which a black layer is formed on a front surface of a base.

FIG. 4 is a cross-sectional side view showing a modification in which an infrared transmissive cover is also used as a cover.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

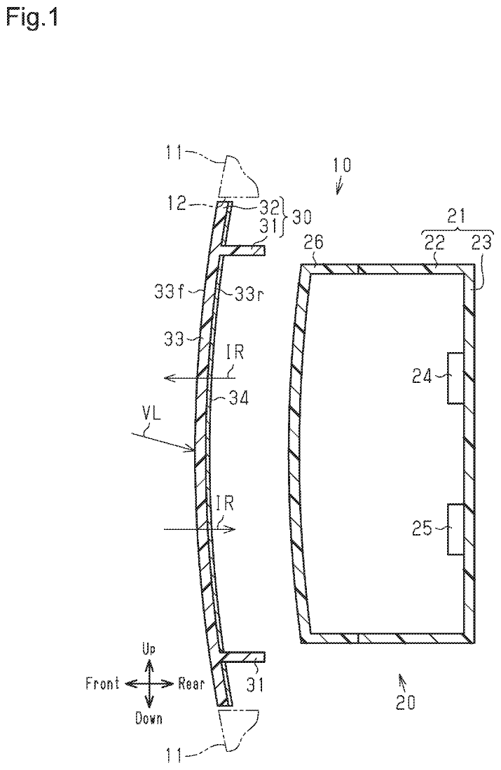

An infrared transmissive product for a vehicle 10 according to an embodiment will now be described with reference to FIG. 1. In the embodiment, the infrared transmissive product is an infrared transmissive cover 30.

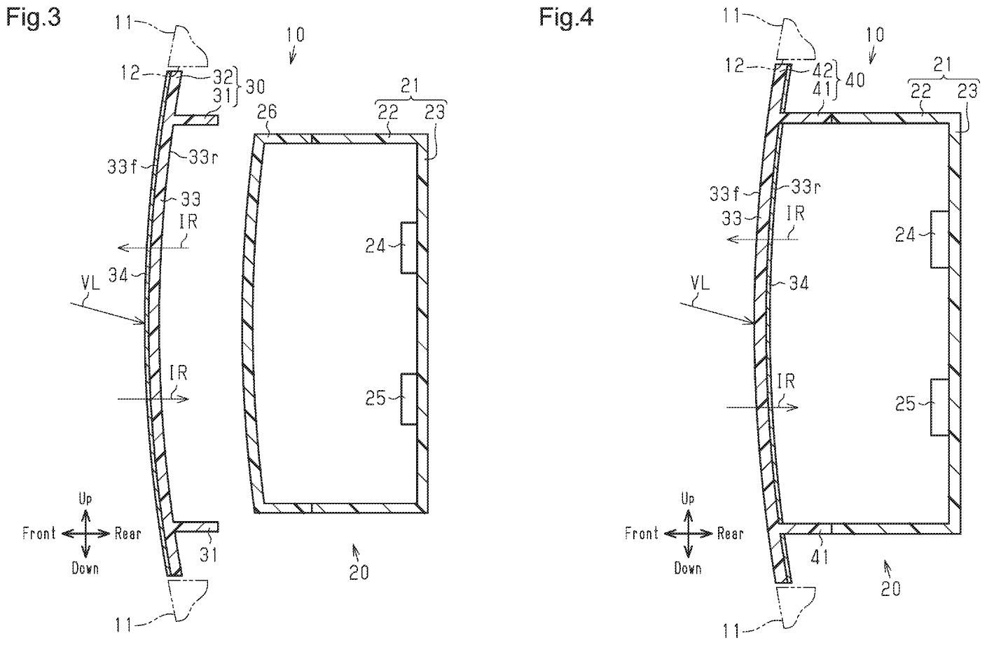

In the following description, the direction in which the vehicle 10 advances forward will be referred to as the front, and the reverse direction will be referred to as the rear. The vertical direction refers to the vertical direction of the vehicle 10, and the left-right direction refers to the vehicle width direction that matches with the left-right direction as viewed from a front-facing occupant. In FIG. 1, in order to make the size of each component of the infrared transmissive cover 30 recognizable, the scale of each component is altered as necessary. The same applies to FIGS. 3 and 4, which show modifications.

As shown in FIG. 1, the vehicle 10 is equipped with a sensor that detects the surrounding environment. The sensor is an infrared sensor 20 that is arranged at the front part of the vehicle 10 and located at the center in the left-right direction. The infrared sensor 20 is arranged behind a front grille 11.

The infrared sensor 20 is configured to transmit infrared rays IR forward from the vehicle 10 and receive the infrared rays IR that have struck and been reflected by an object outside the vehicle 10, such as a leading vehicle or a pedestrian. The infrared rays IR are of a type of electromagnetic waves and have wavelengths that are longer than the wavelengths of visible light rays VL and shorter than the wave lengths of radio waves. Based on the transmitted infrared rays IR and the received infrared rays IR, the infrared sensor 20 recognizes the object outside the vehicle 10, and detects the distance between the vehicle 10 and the object and the relative velocity.

As described above, the infrared sensor 20 transmits the infrared rays IR forward from the vehicle 10. Thus, the transmission direction of the infrared rays IR from the infrared sensor 20 is the direction from the rear toward the front of the vehicle 10. The front in the transmission direction of the infrared rays IR substantially matches with the forward direction of the vehicle 10. The rear in the transmission direction also substantially matches with the rear of the vehicle 10. Accordingly, in the following description, the front in the transmission direction of the infrared rays IR will simply be referred to as “front” or “forward.” The rear in the transmission direction will simply be referred to as “rear” or “rearward.”

The rear half of the outer shell of the infrared sensor 20 is formed by a case 21. The front half of the outer shell of the infrared sensor 20 is formed by a cover 26. The infrared sensor 20 is fixed, for example, to a vehicle body.

The case 21 includes a tubular peripheral wall 22 and a bottom wall 23, which is provided at the rear end of the peripheral wall 22. The case 21 has the shape of a tube with an open front end and a closed end. The case 21 is entirely made of a plastic such as a polybutylene terephthalate plastic. A transmitting unit 24, which transmits infrared rays IR, and a receiving unit 25, which receives the infrared rays IR, are arranged on the front side of the bottom wall 23.

The cover 26 is made of a plastic that contains a visible light blocking pigment. Examples of such a plastic include, for example, polycarbonate, polymethacrylic acid methyl, cycloolefin polymer, and plastic glass. The cover 26 is arranged in front of the case 21 to cover the transmitting unit 24 and the receiving unit 25 from the front.

The front grille 11 has a window 12, which opens in front of the infrared sensor 20. The infrared transmissive cover 30 of the present embodiment is arranged in the window 12. The infrared transmissive cover 30 includes a plate-shaped cover body 32 and an attachment portion 31 protruding rearward from the cover body 32. The cover body 32 may also be referred to simply as the body. The cover body 32 is located in front of the cover 26 to indirectly cover the transmitting unit 24 and the receiving unit 25 from the front with the cover 26 in between. The infrared transmissive cover 30 is attached, for example, to the vehicle body at the attachment portion 31.

The infrared transmissive cover 30 is used as the cover for the infrared sensor 20 and also as a garnish for decorating the front part of the vehicle 10.

The cover body 32 includes a base 33 and a black layer 34. The base 33 is made of a transparent plastic having an infrared transmissivity, for example, the same plastic used for the cover 26.

The black layer 34 is configured to ensure the detection accuracy of the infrared sensor 20 by limiting passage of visible light rays VL while allowing for passage of infrared rays IR.

The black layer 34 includes a black coating film layer. The coating film layer is formed by combining a transparent plastic and at least two types of dyes/pigments that have infrared transmissivity and produce a black color when mixed together. The black layer 34 may contain a curing agent.

The transparent plastic as used herein contains at least one of the following as a main component: epoxy plastic, silicone plastic, urethane, urea-formaldehyde plastic, phenol plastic, polyethylene, polypropylene, polyethylene terephthalate, vinyl chloride, polystyrene, acrylonitrile-butadiene-styrene copolymer, acrylic plastic, polyamide, polyimide, polycarbonate, and melamine plastic. The “main component” refers to a component that affects the properties of the material, and the content of the “main component” is greater than or equal to 50% by mass.

A curing agent is used depending on the material of the transparent plastic. If the transparent plastic used herein contains epoxy plastic as the main component, an acid anhydride curing agent or a phenol curing agent may be used. If the transparent plastic used herein contains a material other than epoxy plastic as the main component, a curing agent may be omitted.

Depending on the purpose and the intended use, a curing agent other than an acid anhydride curing agent or a phenol curing agent may be used. Examples of such curing agents include an amine-based curing agent, an agent obtained by partially esterificating an acid anhydride curing agent with alcohol, and a curing agent of carboxylic acid such as hexahydrophthalic acid, tetrahydrophthalic acid, and methyl-hexahydrophthalic acid. One of the listed curing agents may be used alone. Alternatively, two or more of the curing agents may be used in combination. Further, any of the curing agents may be used with an acid anhydride curing agent and a phenol curing agent.

The dyes/pigments are selected from a group consisting of the following dyes and all the pigments that can be used as coloring pigments.

Examples of the dye include an azo dye, an anthraquinone dye, an indigoid dye, a carbonium dye, a quinonimine dye, a quinoline dye, a chrome dye, an indanthrene dye, a triphenylmethane dye, a phthalocyanine dye, a procion dye, a methine dye, a nitro dye, a nitroso dye, a benzoquinone dye, a naphthoquinone dye, a naphthalimide dye, a perinone dye, and a remazol dye.

Examples of the pigment include titanium dioxide, zinc oxide, iron oxide, calcined pigment, isoindolinone, isoin, drin, azomethine, anthraquinone, anthrone, xanthene, diketopyrrolopyrrole, perinone, perylene, indigoid, quinacridone, dioxazine, and phthalocyanine. Particularly, oil-soluble dyes/pigments are preferable in order to achieve even dispersion in the black layer 34.

Dyes have the following properties.

Dyes have a wavelength selectivity that allows for passage of light having a specific wavelength and absorbs light having a specific wavelength.

Dyes are more easily dissolved in a solvent than pigments are.

Dyes of different colors are more easily mixed than pigments are.

In the formation of the black layer 34, two or more types of dyes/pigments that meet the following conditions are selected from the groups of the dyes/pigments shown above and used.

Condition 1

The dyes/pigments each have a color different from a black color but produce a black color when mixed together. The black color is a color that absorbs and blocks all colors without reflecting light.

Condition 2

The dyes/pigments have a property of being unable to absorb visible light rays VL of specific regions different from each other.

Condition 3

When mixed together, the dyes/pigments are capable of absorbing visible light rays VL that cannot be absorbed by each of the dyes/pigments alone.

Specifically, dyes/pigments of complementary colors are selected. An example is a combination of a purple dye/pigment and a green dye/pigment. A purple dye/pigment is obtained by mixing, for example, a red dye/pigment and a blue dye/pigment. Also, a green dye/pigment is obtained by mixing, for example, a yellow dye/pigment and a blue dye/pigment.

In a case in which a curing agent is used, a curing accelerator may be used together with the curing agent. In order to complement, for example, the property of allowing infrared rays IR to pass through, antioxidant, deterioration inhibitor, denaturant, coupling agent, antifoaming agent, leveling agent, or mold release agent may be used.

The black layer 34 has a thickness in the range from 5 μm to 50 μm. The black layer 34 contains 50 to 150 parts by mass of dyes/pigments as a whole in relation to 100 parts by mass of transparent plastic.

In the infrared transmissive cover 30, which is configured as described above, the light transmissivity of the cover body 32 is 10% or lower in the wavelength region from 400 nm to 600 nm. Also, the light transmissivity of the cover body 32 is 70% or higher in the wavelength region from 800 nm to 1700 nm.

An operation of the infrared transmissive cover 30 of the above-described embodiment will now be described. Advantages that accompany the operation will also be described.

The light transmissivity at each wavelength of light was measured for the cover body 32 of the infrared transmissive cover 30 according to the present embodiment, in which the black layer 34 met the above-described conditions and the compounding ratio of the dyes/pigments as a whole in relation to the transparent plastic met the above-described conditions. The measurement revealed that passage of visible light rays VL was limited to a lower level in a number of wavelength regions of visible light rays VL, and that the infrared rays IR were allowed to pass through at a high light transmissivity in a wide wavelength region.

Thus, as compared to a product in which the black layer 34 is formed by a single black pigment such as carbon black, the absorption region of the visible light rays VL is widened, and the concealing effect in the same region is improved.

It was discovered that the infrared transmissive cover 30 of the present embodiment allowed infrared rays IR to pass through at a higher light transmissivity than an infrared transmissive cover in which the black layer was formed by replacing, with a paint, the hardened body of the plastic composition disclosed in Japanese Laid-Open Patent Publication No. 2017-167484.

Thus, when the infrared transmissive cover 30 is irradiated with visible light rays VL from the front, the visible light rays VL are absorbed by the black layer 34 after passing through the base 33. In the infrared transmissive cover 30 of the present embodiment, the light transmissivity of the cover body 32 is 10% or lower in the wavelength region from 400 nm to 600 nm. Thus, the cover body 32 appears in a black color from the front of the infrared transmissive cover 30. As a result, the black layer 34 prevents components located behind the infrared transmissive cover 30, particularly the transmitting unit 24 and the receiving unit 25 of the infrared sensor 20 from being visible through the infrared transmissive cover 30. In other words, the black layer 34 shields these components.

When the transmitting unit 24 of the infrared sensor 20 transmits infrared rays IR, the infrared rays IR pass through the black layer 34 and the base 33 in that order. After passing through the cover body 32, the infrared rays IR strike, and are reflected by, an object outside the vehicle 10, such as a leading vehicle or a pedestrian, and then pass through the base 33 and the black layer 34 in that order before being received by the receiving unit 25 of the infrared sensor 20. As described above, in the infrared transmissive cover 30 of the present embodiment, the light transmissivity in the wavelength region from 800 nm to 1700 nm is 70% or higher. This allows the infrared sensor 20 to properly recognize the object, and detect the distance between the vehicle 10 and the object, and the relative velocity.

Hereinafter, the above-described embodiment will be described more specifically with reference to Examples and Replicated Examples.

### Examples 1, 2 and Replicated Examples 1 to 3

The components on Table 1 (shown below) were combined at ratios shown in Table 1 and mixed while being melted, thereby preparing paints of Examples 1, 2 and Replicated Examples 1 to 3. In the preparation, acrylic polyol was used as a transparent plastic, and hexamethylene diisocyanate was used as a curing agent.

Replicated Example 1, Replicated Example 2, and Replicated Example 3 in Table 1 (shown below) respectively correspond to Example 1, Example 2, and Example 3 in Table 1 of Japanese Laid-Open Patent Publication No. 2017-167484.

To distinguish Examples in the publication and Examples in the present disclosure, Example 1, Example 2, and Example 3 in the publication are respectively referred to as Publication Example 1, Publication Example 2, and Publication Example 3.

In Publication Examples 1 to 3, the plastic composition was molded into hardened bodies (wavelength selective filters) having thicknesses of millimeters, and measurement was performed using the hardened bodies as test pieces.

In contrast, in Examples 1 and 2 of the present disclosure, the black layer 34 had a thickness of micrometers (μm).

In Replicated Examples 1 to 3, in which the hardened bodies of the Publication Examples 1 to 3 were replaced by paints, the thicknesses of Publication Examples 1 to 3 had to be matched with the thicknesses of Examples 1 and 2 when preparing the paints. However, if the amount of the light absorbing agent (dye) were reduced by the same ratio as the ratio between the thicknesses, visible light would be more likely to pass through. In order to ensure the function of limiting passage of visible light rays VL, the light absorbing agent (dye) was used in the same amount as the amount of the light absorbing agent (dye) in the hardened body, while reducing the thickness of the paint.

In Example 1, 20 parts by mass of the curing agent, 10 parts by mass of a red dye, 30 parts by mass of a yellow pigment, and 25 parts by mass of a blue pigment were combined with 100 parts by mass of the transparent plastic.

In Example 2, 20 parts by mass of the curing agent, 60 parts by mass of a green dye, and 40 parts by mass of a purple dye were combined with 100 parts by mass of the transparent plastic.

In Replicated Example 1, 20 parts by mass of the curing agent, 100 parts by mass of a light absorbing agent a, and 85 parts by mass of a light absorbing agent c were combined with 100 parts by mass of the transparent plastic. The light absorbing agents a to c were all dyes.

In Replicated Example 2, 20 parts by mass of the curing agent, 100 parts by mass of the light absorbing agent a, and 0.1 parts by mass of the light absorbing agent c were combined with 100 parts by mass of the transparent plastic.

In Replicated Example 3, 20 parts by mass of the curing agent, 100 parts by mass of the light absorbing agent a, and 0.1 parts by mass of the light absorbing agent c were combined with 100 parts by mass of the transparent plastic.

In Replicated Example 2, the dye was not dispersed, and no paint was formed.

In Replicated Example 3, the light absorbing agent a was excessive and greater than or equal to 100% in volume fraction, and no paint was formed.

The mass of the solid content in the entire black layer 34, the mass of the solid content in the entire dye, and the ratio of the solid content of the entire dye to the entire black layer 34 had values shown in the middle section of Table 1.

The paints of Examples 1, 2 and Replicated Example 1 were applied to bases made of the same material as that of the base of the infrared transmissive cover 30 to form coating film layers having a thickness of 25 μm, thereby preparing test pieces each including a base and a black layer.

<Regarding Details and Results of Measurement>

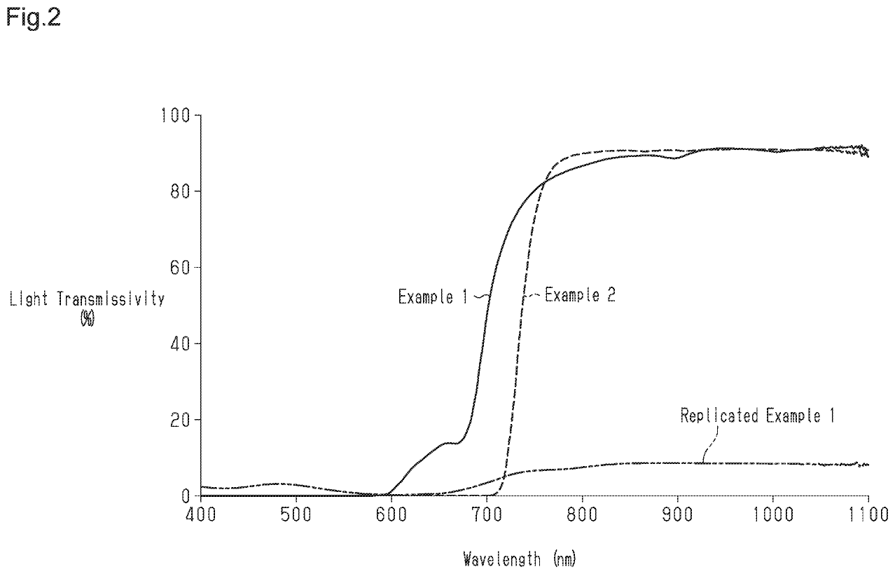

The light transmissivities of the test pieces, which were prepared in the above-described manner, were measured at various wavelengths using a spectrophotometer. The measurement results of the light transmissivities are shown in the lower section of Table 1 and FIG. 2.

TABLE 1

| | | | | Replicated | Replicated | Replicated |
|---|---|---|---|---|---|---|
| | | Example 1 | Example 2 | Example 1 | Example 2 | Example 3 |
| Transparent Plastic | Parts | 100 | 100 | 100 | 100 | 100 |
| Curing Agent | by | 20 | 20 | 20 | 20 | 20 |
| Light Absorbing Agent a (Dye) | Mass | — | — | 100 | 100 | 100 |
| Light Absorbing Agent b (Dye) | | — | — | — | — | — |
| Light Absorbing Agent c (Dye) | | — | — | 85 | 0.1 | 0.1 |
| Dye (Red) | | 10 | — | — | — | — |
| Pigment (Yellow) | | 30 | — | — | — | — |
| Pigment (Blue) | | 25 | — | — | — | — |
| Dye (Green) | | — | 60 | — | — | — |
| Dye (Purple) | | — | 40 | — | — | — |
| Solid Content in Entire Black Layer | Parts by | 38.1 | 42.3 | 320 | Dye not | Dye excessive |
| Solid Content in Entire Dye | Mass | 4.0 | 6.8 | 200 | dispersed | (paint not |
| Ratio of Solid Content of Dye to Entire Black Layer | % | 10.5 | 16.1 | 62.5 | | formed) |
| Light Transmissivity at Wavelength of 900 nm | % | 86.7 | 91.0 | 12.5 | | |
| Light Transmissivity at Wavelength of 550 nm | | 0.0 | 0.0 | 0.0 | | |
| Average of Light Transmissivities in Wavelength | | 0.3 | 0.0 | 0.0 | | |
| Region from 380 nm to 700 nm | | | | | | |

As discussed in BACKGROUND, if a black layer is formed by applying a paint made of a single black pigment such as carbon black, the light transmissivity in a specific wavelength region of visible light rays VL (450 nm to 500 nm) is higher than those in other wavelength regions. In other words, the light transmissivity has a peak.

In contrast, the light transmissivities of Examples 1, 2 and Replicated Example 1 in the specific wavelength region of the visible light rays VL were not significantly higher than those in other regions. That is, the light transmissivities of Examples 1, 2 and Replicated Example 1 did not have peaks.

Also, the light transmissivity was 10% or lower in the wavelength region from 400 nm to 760 nm in Replicated Example 1, in the wavelength region from 400 nm to 630 nm in Example 1, and in the wavelength region from 400 nm to 720 nm in Example 2. The light transmissivity at the wavelength of 550 nm was 0% in all of Examples 1 and 2 and Replicated Example 1, as shown in the lower section of Table 1.

The average of the light transmissivities in the wavelength region from 380 nm to 700 nm was low in all of Example 1, Example 2, and Replicated Example 1, as shown in the lower section of Table 1.

This reveals that the light transmissivity was low in a wide wavelength region of the visible light rays VL, so that the visible light rays VL were unlikely to pass through in Examples 1 and 2.

The light transmissivity of Replicated Example 1 was low over the entire wavelength region of the infrared rays IR. The light transmissivity was 8.8% at a maximum, and the infrared rays IR did not sufficiently pass through. This is considered to be because the concentration of the light absorbing agent (dye) in the black layer 34 was higher than the threshold acceptable value.

In contrast, in Example 1, the light transmissivity abruptly changed from 18% to 80% in the wavelength region from 680 nm to 750 nm, and fluctuated in the range from 80% to 91% in the wavelength region from 750 nm to 1100 nm.

In contrast, in Example 2, the light transmissivity abruptly changed from 18% to 80% in the wavelength region from 720 nm to 760 nm, and fluctuated in the range from 80% to 91% in the wavelength region from 760 nm to 1100 nm.

In both of Examples 1 and 2, the light transmissivity in the wavelength region from 800 nm to 1100 nm was 70% or higher. The light transmissivity at the wavelength of 900 nm was as high as approximately 90%, as shown in the lower section of Table 1.

This reveals that, in either Example 1 or Example 2, the light transmissivity was sufficiently high in the wavelength region of the infrared rays IR, so that a great amount of the infrared rays IR passed through.

The above-described embodiment may be modified as follows. The above-described embodiment and the following modifications can be combined as long as the combined modifications remain technically consistent with each other.

In the above-described embodiment, a layer having a different function may be provided behind the black layer 34.

As shown in FIG. 3, the black layer 34 of the cover body 32 may be formed on a front surface 33f of the base 33, instead of a rear surface 33r. In this case, the base 33 needs to be made of a plastic having an infrared transmissivity, but does not necessarily need to be transparent.

In the above-described embodiment, the visible light rays VL are applied to the black layer 34 after passing through the base 33. This modification is different from the above-described embodiment in that the visible light rays VL are directly applied to the black layer 34 without passing through the base 33. However, this modification is similar to the above-described embodiment in that the visible light rays VL are absorbed by the black layer 34 in a number of wavelength regions.

In this modification, the infrared rays IR transmitted from the transmitting unit 24 pass through the base 33 and the black layer 34 in that order. Then after striking, and being reflected by, an object outside the vehicle, the infrared rays IR pass through the black layer 34 and the base 33 in that order before being received by the receiving unit 25. In this respect, this modification is different from the above-described embodiment, in which the transmitted infrared rays IR pass through the black layer 34 and the base 33 in that order, and the reflected infrared rays IR pass through the base 33 and the black layer 34 in that order. However, this modification is similar to the above-described embodiment in that the infrared rays IR pass through the black layer 34.

Therefore, this modification has the same advantages as the above-described embodiment.

In this modification, a layer having a different function may be provided in front of the black layer 34.

In the above-described embodiment, the infrared transmissive cover 30 is provided separately from the infrared sensor 20. However, an infrared transmissive cover may be a part of the infrared sensor 20.

More specifically, the cover 26, which is the front half of the outer shell of the infrared sensor 20 in FIG. 1, may be formed by the infrared transmissive cover 40 shown in FIG. 4. The infrared transmissive cover 40 includes a tubular peripheral wall 41 and a plate-shaped cover body 42 provided at the front end of the peripheral wall 41. The cover body 42 may also be referred to simply as the body. The peripheral wall 41 is located in front of and adjacent to the peripheral wall 22 of the case 21. The peripheral portion of the cover body 42, which extends further outward than the peripheral wall 41, does not necessarily need to extend further outward than the peripheral wall 41. Most of the cover body 42 is located in front of the bottom wall 23 of the infrared sensor 20 and covers the transmitting unit 24 and the receiving unit 25 from the front.

Even in this modification, the infrared transmissive cover 40 is used as the cover for the transmitting unit 24 and the receiving unit 25 and also as a garnish for decorating the front part of the vehicle 10.

The layer structure of the cover body 42 is the same as the layer structure of the cover body 32 in the above-described embodiment and FIG. 3. Therefore, this modification has the same operations and advantages as the above-described embodiment and the modification of FIG. 3.

The infrared transmissive covers 30, 40 can be used in a case in which the infrared sensor 20 is mounted in a section of the vehicle 10 different from the front part, for example, in the rear part. In this case, the transmitting unit 24 transmits infrared rays IR rearward from the vehicle 10. The infrared transmissive covers 30, 40 are arranged in front of the transmitting unit 24 in the transmission direction of the infrared rays IR, that is, behind the transmitting unit 24 in the vehicle 10.

The infrared transmissive covers 30, 40 can be used in a case in which the infrared sensor 20 is mounted in each of the side sections in the front part or the rear part of the vehicle 10, that is, the front corners or the rear corners.

The infrared transmissive product may be embodied as a product different from the above-described infrared transmissive covers 30, 40 as long as the product covers the transmitting unit 24 and the receiving unit 25 of the infrared sensor 20 from the front in the transmission direction of the infrared rays IR.

The infrared transmissive product may be embodied as a product that covers a transmitting unit and a receiving unit of an infrared sensor used in a field different from the field of vehicles.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

What is claimed is:

1. An infrared transmissive product, comprising:
a body configured to cover a transmitting unit and a receiving unit for infrared rays in an infrared sensor, wherein
the body includes
a base made of a transparent plastic having an infrared transmissivity, and
a black layer that is formed on a rear surface of the base in a transmission direction of infrared rays from the transmitting unit,
the black layer includes a coating film layer, the coating film layer being formed by combining a transparent plastic and at least two types of dyes/pigments that have an infrared transmissivity and produce a black color when mixed together,
the black layer has a thickness in a range from 5 μm to 50 μm, and
the black layer contains 50 to 150 parts by mass of the dyes/pigments as a whole in relation to 100 parts by mass of the transparent plastic.

2. The infrared transmissive product according to claim 1, wherein the dyes/pigments are selected from a group consisting of an azo dye, an anthraquinone dye, an indigoid dye, a carbonium dye, a quinonimine dye, a quinoline dye, a chrome dye, an indanthrene dye, a triphenylmethane dye, a phthalocyanine dye, a procion dye, a methine dye, a nitro dye, a nitroso dye, a benzoquinone dye, a naphthoquinone dye, a naphthalimide dye, a perinone dye, a remazol dye, titanium dioxide, zinc oxide, iron oxide, calcined pigment, isoindolinone, isoin, drin, azomethine, anthraquinone, anthrone, xanthene, diketopyrrolopyrrole, perinone, perylene, indigoid, quinacridone, dioxazine, and phthalocyanine.

3. The infrared transmissive product according to claim 1, wherein a light transmissivity of the body in a wavelength region from 400 nm to 600 nm is 10% or lower.

4. The infrared transmissive product according to claim 1, wherein a light transmissivity of the body in a wavelength region from 800 nm to 1700 nm is 70% or higher.

5. An infrared transmissive product, comprising:
a body configured to cover a transmitting unit and a receiving unit for infrared rays in an infrared sensor, wherein
the body includes
a base made of a plastic having an infrared transmissivity, and
a black layer that is formed on a front surface of the base in a transmission direction of infrared rays from the transmitting unit,
the black layer includes a coating film layer, the coating film layer being formed by combining a transparent plastic and at least two types of dyes/pigments that have an infrared transmissivity and produce a black color when mixed together,
the black layer has a thickness in a range from 5 μm to 50 μm, and
the black layer contains 50 to 150 parts by mass of the dyes/pigments as a whole in relation to 100 parts by mass of the transparent plastic.

6. The infrared transmissive product according to claim 5, wherein the dyes/pigments are selected from a group consisting of an azo dye, an anthraquinone dye, an indigoid dye, a carbonium dye, a quinonimine dye, a quinoline dye, a chrome dye, an indanthrene dye, a triphenylmethane dye, a phthalocyanine dye, a procion dye, a methine dye, a nitro dye, a nitroso dye, a benzoquinone dye, a naphthoquinone dye, a naphthalimide dye, a perinone dye, a remazol dye, titanium dioxide, zinc oxide, iron oxide, calcined pigment, isoindolinone, isoin, drin, azomethine, anthraquinone, anthrone, xanthene, diketopyrrolopyrrole, perinone, perylene, indigoid, quinacridone, dioxazine, and phthalocyanine.

7. The infrared transmissive product according to claim 5, wherein a light transmissivity of the body in a wavelength region from 400 nm to 600 nm is 10% or lower.

8. The infrared transmissive product according to claim 5, wherein a light transmissivity of the body in a wavelength region from 800 nm to 1700 nm is 70% or higher.
